(19) United States
(12) Patent Application Publication
(10) Pub. No.: US 2006/0059145 A1
(43) Pub. Date: Mar. 16, 2006

(54) System and method for analyzing medical data to determine diagnosis and treatment

(76) Inventors: Claudia Henschke, New York, NY (US); Anthony P. Reeves, Ithaca, NY (US); David Yankelevitz, Brooklyn, NY (US)

Correspondence Address: Fay Kaplun & Marcin, LLP, Suite 702, 150 Broadway, New York, NY, 10038, US

(21) Appl. No.: 10/932,443

(22) Filed: Sep. 2, 2004

(51) Int. Cl. G06F 17/30

(52) U.S. Cl. 707/6

(57) ABSTRACT

Described is a system and method for generating an action plan for diagnosis and treatment of a patient. In particular, a historical database is complied which includes a plurality of records. Each record includes a personal profile and diagnosis data for a person. A plurality of characterizations and corresponding weighting coefficients are derived based on the records in the historical database. Pre-diagnostic patient profile data for a selected patient is obtained for the selected patient. One or more computing modules generate output data for the selected patient as a function of (i) the pre-diagnostic patient profile data, along with the physician's modifications, if any and (ii) the plurality of characterizations and corresponding weighting coefficients. The output data includes at least one of a diagnostic action plan, a confirmation action plan, a confirmation patient profile data and a therapeutic action plan.

### FIELD OF THE INVENTION

The present invention relates to a system and method for diagnosis and treatment by training at least one computing module with medical data to determine diagnosis and treatment for patient conditions.

### BACKGROUND OF THE INVENTION

Diagnoses and treatments of patient conditions, including illness, are conventionally processed manually by medical professionals. For example, medical data, such as, for example, radiology data including radiology images, may be generated by having a patient's radiology test results reviewed by a radiologist who then writes or otherwise personally generates a report. The radiologist's report is then sent to a physician who will develop a diagnosis and potential treatment options for the patient. Although there are certainly established protocols for handling such information, this is a time consuming process that has many potential variabilities depending on the policies established by the individual professionals or by medical facilities. As a result, patient treatment may be delayed.

Furthermore, diagnosis and/or treatment of patients performed manually by medical professionals are based on generalizations and broad categories. The analysis is neither personalized nor tailored to the needs of an individual patient. For example, the current method of diagnosing and/or treating cancer is to categorize the patient within a predetermined category, e.g., a specific cancer stage. Each category is related to a set of broad generalizations for diagnosis and treatment. For example, every patient within the same stage is given the same treatment regardless of other personal factors that may affect the patient's health risk or recovery potential.

### SUMMARY OF THE INVENTION

The present invention relates to a system and method for generating personalized action plans for diagnosis and treatment of a patient. In particular, a historical database is compiled which includes a plurality of records. Each record includes a personal profile and diagnosis data for a person. A plurality of characterizations and corresponding weighting coefficients are derived based on the records in the historical database. Pre-diagnostic patient profile data is obtained for the selected patient. The physician may choose to modify the pre-diagnostic patient profile data and/or any intermediate output data.

A computing module generates output data for the selected patient as a function of (i) the pre-diagnostic patient profile data along with the physician's modifications, if any and (ii) the plurality of characterizations and corresponding weighting coefficients. The output data includes at least one of a diagnostic action plan, a confirmation action plan and a therapeutic action plan.

### BRIEF DESCRIPTION OF THE DRAWINGS

FIG. 1 shows an exemplary embodiment of a system for analyzing medical data to determine diagnosis and treatment according to the present invention;

FIG. 2a shows an exemplary embodiment of a method for analyzing medical data to determine diagnosis and treatment according to the present invention; and

FIG. 2b shows an exemplary method for obtaining patient profile data within the method illustrated in FIG. 2a.

FIG. 2c shows an exemplary method for generating a preliminary diagnosis within the method illustrated in FIG. 2a.

FIG. 2d shows an exemplary method for confirming a probable diagnosis within the method illustrated in FIG. 2a.

FIG. 2e shows an exemplary method for selecting a treatment action plan within the method illustrated in FIG. 2a.

FIG. 2f shows an exemplary method for updating the computing modules within the method illustrated in FIG. 2a.

FIG. 3 shows an exemplary embodiment of a profile of a patient.

### DETAILED DESCRIPTION

The present invention may be further understood with reference to the following description of preferred exemplary embodiments and the related appended drawings, wherein like elements are provided with the same reference numerals. It should be understood that, although the preferred embodiment of the present invention will be described with reference to conducting medical data analysis using radiology image data, the present invention may be implemented on a wide range of medical data including, for example, photographic image data, optical projection image data, image data of DNA chips, blood test report, etc., and the term “medical data” will be used through out this description to generically refer to all such types of data.

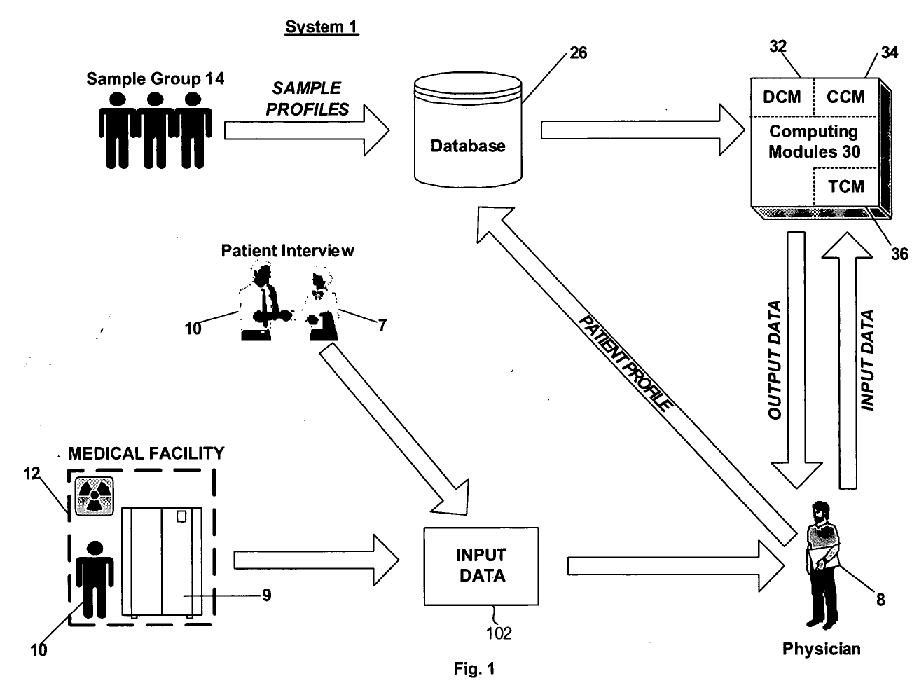

FIG. 1 shows an exemplary embodiment of a system 1 for analyzing medical data to determine diagnosis and treatment of a patient 10. The system 1 may include one or more participating medical facilities 12 where the patient 10 is examined. The medical facility 12 may be, for example, a hospital, a medical clinic, a physician's private office, etc. Each medical facility 12 may include one or more sources (e.g., medical equipment, medical personnel) for collecting the patient's 10 medical data. For example, the medical facility 12 may have a radiology imaging device 9 such as CAT scan device, MRI device, etc. The system 1 may also include a physician 8, a patient interviewer 7, a sample group 14, a database 26, and computing modules 30. Those skilled in the art would understand that the system 1 may include any number of computing modules 30 which may assist in diagnosis and treatment. In a preferred embodiment, the computing modules 30 may include a diagnostic computing module (DCM) 32, a confirmation computing module (CCM) 34, and a treatment computing module (TCM) 36. Alternatively, the system may include a single computing module 30 which serves the diagnostic, confirmation and treatment computing modules.

The sample group 14 may include a plurality of patients who have been previously diagnosed and/or treated. A profile 100 may be generated for each patient 10 within the sample group 14. Furthermore, the sample group profiles may be collected by different levels of data collection. Thus, some of the sample group data may include partial profiles. For example, some sample group profiles may only provide confirmation records, while other sample group profiles may provide confirmation and treatment records.

The profile 100, which can be seen in FIG. 3, may include input data 102, output data 104 and clinical data 106. The input data 102 may include a personal information section 108 (e.g., age, height, weight, race, occupation, etc.). Preferably, any information that would reveal the identity of a former patient (e.g. name, address, social security number) is removed to maintain the patient's privacy and comply with government privacy regulations, such as, for example, the Health Insurance Portability and Accountability Act of 1996 (HIPAA).

The HIPPA imposes national standards for electronic health care transactions and national identifiers for providers, health plans, and employers. The HIPAA also mandates regulations for the security and privacy of health data. The preferred embodiment of the present invention provides for a system 1 which is compliant with the privacy requirements for handling the wide spread use of electronic data interchange in health care.

The input data 102 may further include a medical data section 110 which can encompass any type of medical information (e.g., pathology data, radiology data, medical test results, prior medical conditions, size and/or location of a nodule, symptoms, family history, state of health, chronic diseases, allergies, lifestyle information, etc.). The medical data section 110 may further include specific genetic information, including human molecular genetic data which is becoming more important as relationships to different types of cancer are being discovered and documented. For example, there are certain genetic markers that can predict an aggressiveness of tumors. The significance of genetic markers has been recognized for breast cancer and this type of information is expected to become increasing significant for other types of cancers as well.

The output data 104 contained in the profile 100 may include a preliminary diagnosis section 112, a confirmation plan section 114, a confirmation data section 116 and a treatment plan section 118. The preliminary diagnosis section 112 may include one or more probable diagnosis based on the input data 102 for a specific patient 10. The preliminary diagnosis section 112 may further include the likelihood of each probable diagnosis. The confirmation plan section 114 may provide a recommended confirmation process along with its alternatives. The confirmation process may be any type of medical examination procedures or a combination thereof (e.g., further examination by the physician, more detailed interview, further radiological examination, biopsy, blood test, DNA analysis, etc.). The confirmation data section 116 may include the prescribed confirmation process along with the medical data obtained by the prescribed confirmation process. Preferably, the prescribed confirmation process may be at least one of the confirmation processes revealed in the confirmation plan section 114. The treatment plan section 118 may provide a recommended treatment processes and alternative treatment processes; each may specify the treatment schedule, medication, exercise, diet, etc. The treatment plan section 118 may further indicate the likelihood of success of each suggested treatment process.

The clinical data 106 may contain information about the actual treatment. As shown in FIG. 3, an exemplary embodiment of the clinical data 106 may include an actual treatment process section 120 and a treatment results section 122. The actual treatment process section 120 may reveal the prescribed treatment which includes the actual treatment schedule, the point at which the treatment is at temporally (e.g., months, years, terminated, etc.), medications, exercise, diet, etc. The treatment result section 122 may provide the effect of the treatment (e.g., failed, successful, percent recovery, side effects, etc.) and medical data obtained during the treatment process (e.g., monitoring data, progress reports, etc.).

As would be understood by those skilled in the art, the profile 100 may include any information that is deemed relevant to treatment and diagnosis.

The input data 102, the output data 104 and the clinical data 106 in the profile may preferably be standardized and divided into predetermined characterizations. For example, the physician 8, attempting to diagnose and treat the patient 10, may want to access the profile 100 from the sample group 14 with similar size and/or location of a nodule, age, height, weight, race, occupation, etc. In one embodiment, each characterization is given a corresponding weighting coefficient based on a correlation to prior diagnoses, contrary to diagnosis based on broad categories, such as cancer staging. For example, weight over a certain threshold may make the patient 10 more susceptible to illness, certain treatment plans may be more beneficial based on the age of the patient 10, or the probability of a cancer being cured given the particular patient profile 100 or a particular treatment process 120.

The profiles 100 of the sample group 14 are stored in the database 26. As would be understood by those skilled in the art, profiles 100 of subsequent patients 10 may be added to the database 26 and/or profiles 100 may be deleted from the database 26. For example, a certain treatment plan may be ineffective, and the profiles 100 that include that treatment plan could be deleted from the database 26. After adding or deleting profiles 100 from the database 26, or at any predetermined or desired time, the characterizations and the corresponding weighting coefficients may be reviewed and adjusted.

Based on the characterizations and the corresponding weighting coefficients, computing modules 30 are generated. The computing modules 30 may include any of a number of adaptive self-learning error correction systems employing automated recognition systems for classifying and identifying patterns as objects within a library of objects, such as a recognition system including one or more feed forward, feed back multiple neural networks. For an illustration of such a system, see, for example, Yoh-Han Pao, Adaptive Pattern Recognition and Neural Networks, Addison-Wesley Publishing Co., 1989. The computing modules 30 may also be logically programmed from the data in the profiles 100 as dedicated or generalized expert systems. With each additional profile 100 that is added to the database 26, the computing modules 30 become more accurate in assessing diagnostic data and effective treatment options.

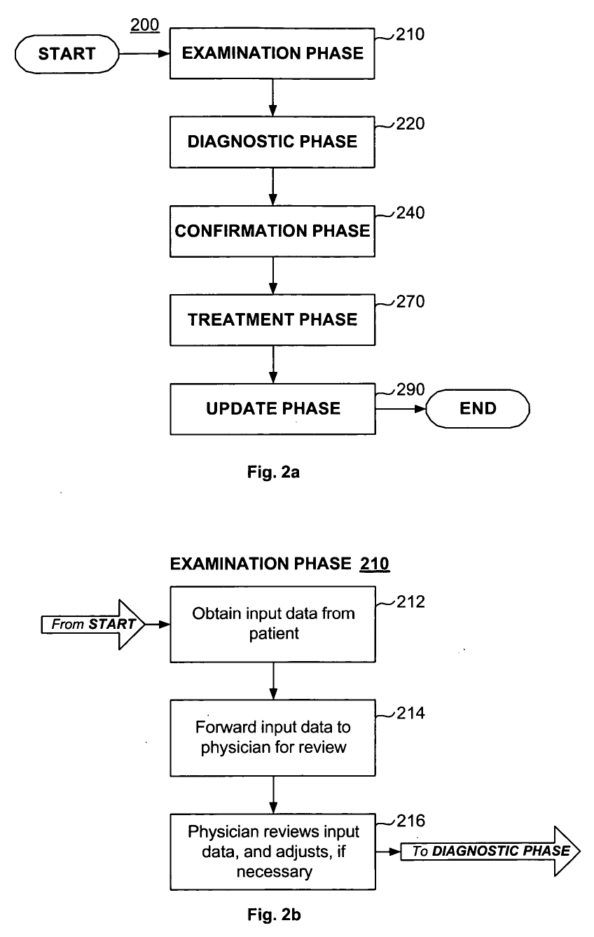

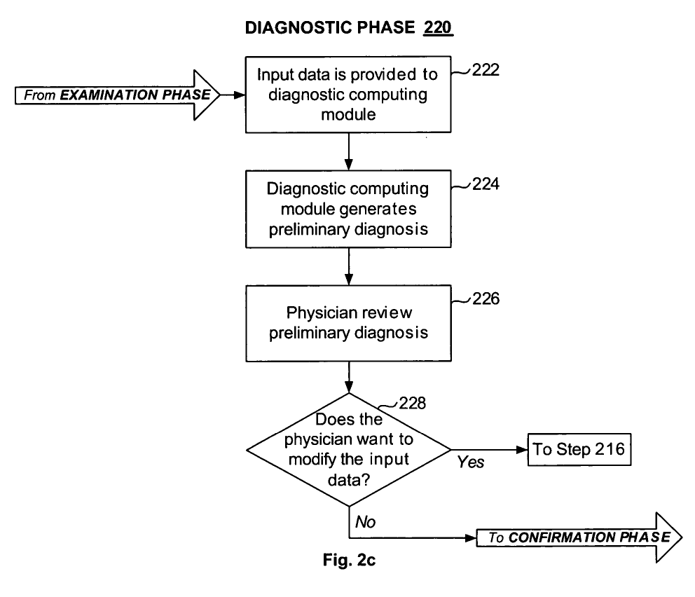

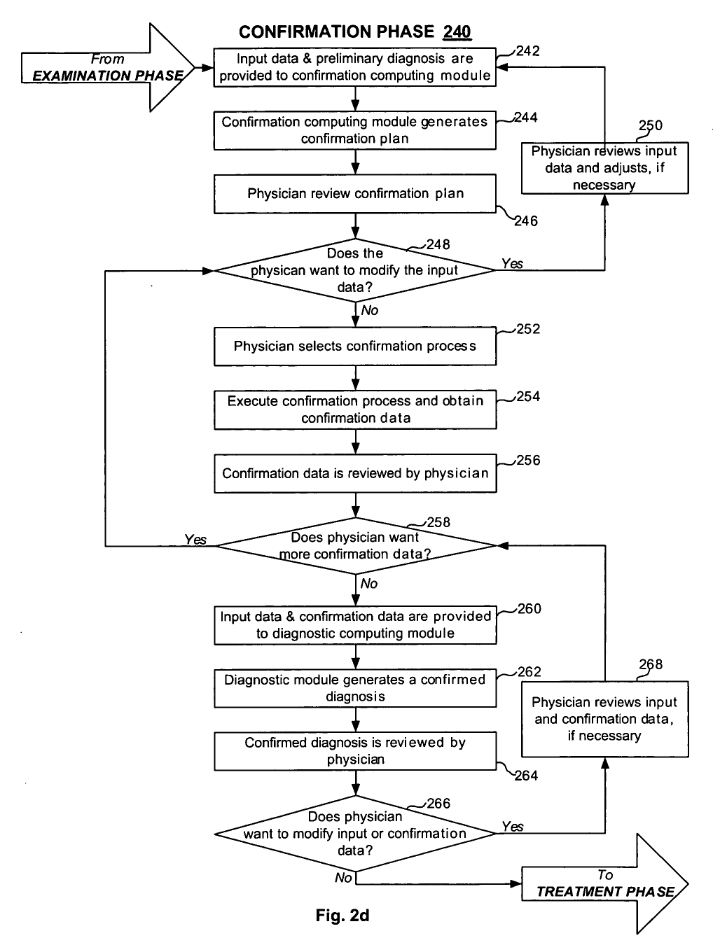

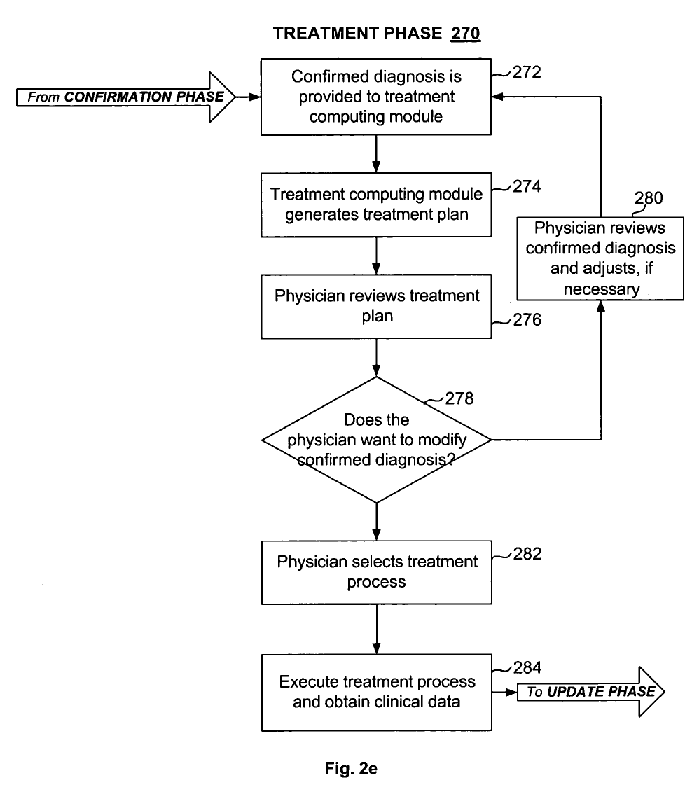

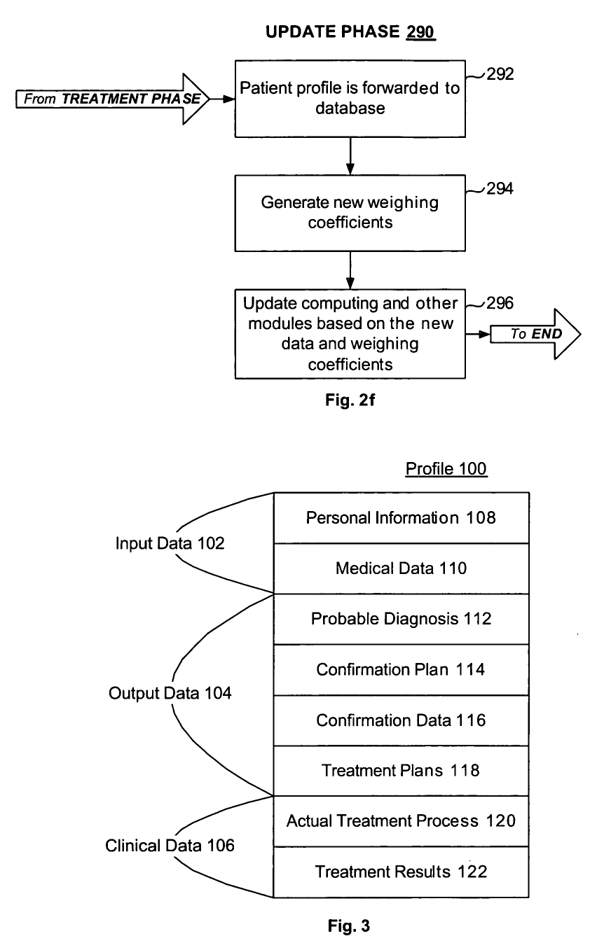

An exemplary method according to the present invention is shown in FIG. 2a. The method 200 may have five phases: an examination phase 210, a diagnostic phase 220, a confirmation phase 240, a treatment phase 270, and an update phase 280. During the examination phase 210, the patient input data 102 is obtained. Subsequently, during the diagnostic phase 220, a preliminary diagnosis, which may include the probable diagnosis along with the likelihood of each probable diagnosis is generated. The confirmation phase 240 confirms the probable diagnoses and may further generate a recommended treatment process. The prescribed treatment process along with its results may be generated in the treatment phase 270. Lastly, within the update phase 290, the computing modules 30 may be updated and adjusted, if necessary, based on the patient profile 100.

FIG. 2b shows an exemplary embodiment of the examination phase 210, during which patient input data 102 is obtained. In this exemplary method, the examination phase 210 begins with step 212, where the input data 102 is obtained from a patient 10. In particular, the patient 10 may undergo a personal interview conducted by the patient interviewer 7 or other person that can obtain personal and/or medical information from the patient 10. The patient 10 may also undergo a medical procedure or examination at the medical facility 12. In one exemplary embodiment of the present invention, the medical facility 12 performs a radiological procedure on the patient 10 to generate radiological imaging data. Such radiological image data together with information gathered by the patient interviewer 7 and laboratory tests may be used to generate the input data 102. The radiological procedure may include a Computerized Tomography (CT) scan, Magnetic Resonance Imaging (MRI), Positron Emission Technology (PET), X-Rays, Vascular Interventional and Angiogram/Angiography procedures, ultrasound imaging, radiographs, optical imaging, pathological imaging, molecular imaging, medical genetic imaging and similar procedures. In this exemplary embodiment, the radiological imaging data may be processed either manually by a medical evaluator (e.g., radiologist) or automatically to generate the medical data 108.

The input data 102 is then compiled and forwarded to the physician 8 for review (step 214). As would be understood by those skilled in the art, the transfer of the input data 102 may be accomplished by any known method including, but not limited to, courier, fax, email, etc. In one embodiment, the physician 8 is notified that the input data 102 of the patient 10 is available, and the physician 8 may then access the input data 102 via a communications network, such as the Internet, a wide area network, etc. (not shown).

In step 216, the physician 8 reviews the input data 102 and makes assessments. Those assessments may lead him to adjust the characterizations of the input data 102. For example, the physician 8 may want to assess an array of characterizations so as to obtain a range of probable diagnosis to aid him in providing the patient 10 with the appropriate diagnosis. In this example, the physician 8 may incrementally modify the characterizations of the input data 102 and provide each modification to the DCM 32.

An exemplary method for the diagnostic phase 220, as shown in FIG. 2c, begins by providing the input data 102, with or without any adjustments, to the DCM 32 for analysis (step 222). In step 224, the DCM 32 generates the preliminary diagnosis 112 based on the input data 102 and the diagnostic characterizations and corresponding weighting coefficients that it has been trained with based on the profiles 100 of the database 26. The physician 8 also has an option to review the preliminary diagnosis 112 and make assessments (step 226). Based on these assessments, the diagnostic characterizations of the input data 102 may be modified/adjusted and re-submitted to the DCM 32 for further analysis (steps 226 and 228); such as, to generate further preliminary diagnosis 112. For example, if the preliminary diagnosis 112 generated indicates that the patient 10 is currently not at risk for heart disease, the physician 8 may, however, choose to incrementally observe the risk trends as the patient ages so as to recommend preventative measures (e.g., exercise, diet, quit smoking).

FIG. 2d shows an exemplary embodiment of the confirmation phase 240 of the method illustrated in FIG. 2a. The confirmation phase 240 consists of steps which confirm the preliminary diagnosis 112 generated during the diagnostic phase 220. First, the preliminary diagnosis 112 along with the input data 102, with or without modifications/adjustments to either, are provided to the CCM 34 (step 242). The CCM 34 then generates a confirmation plan 114 based on the input data 102, preliminary diagnosis 112 and the confirmation characterizations and corresponding weighting coefficients derived from the profiles 100 of the database 26 (step 244). Preferably, the confirmation plan 114 should include more than one recommended confirmation process. For example, if a subsequently recommended confirmation process includes a PET scan, then this equipment needs to be available, otherwise, alternative suggestions may be necessary. Alternatively, if the patient 10 declines to undergoing a needle biopsy, then an alternative confirmation process may be recommended.

In step 246, the physician 8 reviews the confirmation plan 114 and assesses the recommended confirmation process and its alternatives. During the confirmation phase 240, the physician 8 has the option to adjust the characterizations of the input data 102 and the preliminary diagnosis 112 and re-submit the adjusted input data to the CCM 34 for further analysis (steps 248 and 250). As would be understood by those skilled in the art, the physician 8 may provide both the preliminary diagnosis 112 and the input data 102 or provide solely the input data 102 along with his own diagnosis, thereby, replacing the preliminary diagnosis 112 and using the system 1 solely to generate confirmation options and not to generate a selection of probable condition.

After reviewing the confirmation plan, the physician 8 prescribes the actual confirmation process (step 252). Preferably, the prescribed confirmation process may be at least one of the recommended confirmation processes generated within the confirmation plan 114, or a combination thereof. In step 254, medical personnel (e.g., physician 8, patient interviewer 7, medical technician, nurse, etc.) may carry out the prescribed confirmation process. In addition, the patient 10 may provide further medical data according to the confirmation process (e.g., further radiological image data, more detailed interview, biopsy results, etc.). The physician 8 reviews the confirmation medical data obtained from the patient according to the prescribed confirmation process and determines if it is sufficient (steps 256 and 258). If the confirmation medical data is insufficient, the physician may return to step 248 to modify the input data and/or prescribe an additional confirmation process based on the generated confirmation plan 114.

Once sufficient confirmation medical data has been collected, at least the input data and the newly collected confirmation data may be submitted to the DCM 32 (step 260). Furthermore, during the confirmation phase 240, the preliminary diagnosis 112 may also be submitted to the DCM 32. Using the corresponding weighting coefficients generated based on the profiles 100 of the database 26, the DCM 32 confirms a diagnosis based on the initially collected input data 102 and the further collected confirmation data 116 (step 262). Preferably, the confirmed diagnosis would be at least one of the preliminary diagnoses 112 generated. In one embodiment, the DCM 32 may generated a confirmed diagnosis by providing an additional diagnostic plan, which contains only a single probable diagnosis. Alternatively, the further generated diagnostic plan may contain the confirmed diagnosis, which is the most probable diagnosis, along with other less likely diagnoses. The likelihood of each diagnosis may be indicated respectively. In another alternative embodiment, the DCM 32 may select the confirmed diagnosis from the list of preliminary diagnoses 112.

Subsequently, in step 264, the physician reviews and assesses the confirmed diagnosis. Based on his assessments, the physician may choose at least one of altering the input data, modifying the confirmation data and collecting more confirmation data (steps 266 and 268); the results of which are resubmitted to the DCM 32 (step 260). As would be understood by those skilled in the art, the physician 8 may alternatively provide the input data 102, the confirmation data 116 and his own diagnosis, thereby, replacing the preliminary diagnosis 112, and using the system 1 solely to confirm his own diagnosis.

The next phase is the treatment phase 270. FIG. 2e illustrates an exemplary embodiment of the treatment phase 270. In step 272, the confirmed diagnosis, with or without modifications, is provided to the TCM 36. Furthermore, at least one of the input data 102, the confirmation data 116, and modifications thereof may also be provided along with the confirmed diagnosis. The TCM 36 may subsequently generate a treatment plan 118 based on the data provided and the treatment characterizations and corresponding weighting coefficients learned from the historical profiles 100 of the database 26 (step 274). Similar to the confirmation plan 114, the treatment plan 118 may provide at least one recommended treatment process. A preferred treatment plan 118 would include alternative options to accommodate resource restraints and patient preferences. In some cases, the patient 10 might prefer to have a surgery as opposed to a radiation therapy form of treatment.

In step 276, the physician 8 reviews the treatment plan 118 and assesses each treatment process provided. Upon reviewing the treatment plan 118, the physician 8 has the option to modify/adjust the characterizations of at least one of the input data 102, the confirmation data 116 and the confirmed diagnosis, if necessary (steps 278 and 280). These data are re-submit to the TCM 36, allowing the physician to obtain a wide range of treatment plans 118. If the physician 8 decides that additional treatment plans 118 are not necessary, he then may prescribe a treatment process (step 282). Preferably, the prescribed treatment process 120 may be one of the treatment processes generated or a combination thereof. The patient is cared for according to the prescribed treatment process 120 (step 284).

The prescribed treatment process 120 establishes a schedule of treatment(s), medication(s), diet(s), etc. However, the prescribed treatment process 120 maybe modified at any time, as needed. For example, patients often react differently to a specific type of treatment. Depending on the patient's response, the prescribed treatment process 120 may be altered to further personalize the actual treatment rendered. As would be understood by those skilled in the art, the physician 8 may provide solely the input data 102 along with his own diagnosis to generate a treatment plan 118, thereby, using the system 1 solely to generate treatment options and not to generate or confirm a diagnosis.

As indicated, the physician 8 may receive the output data 104 (i.e. preliminary diagnosis 112, confirmation plan 114, confirmed diagnosis and treatment plan 118) from the computing modules 30 for as many iterations as desired. As would be understood by those skilled in the art, the computing modules 30 may continuously update the database 26 with new profiles 100, continuously generate new corresponding weighting coefficients, and thereby continuously training and improving itself.

FIG. 2f shows an exemplary updating phase 290 of the method described in FIG. 2a. The updating phase 290 provides an exemplary method which the computing modules 30 may be continuously modified and improved. The physician 8 may compile the profile 100 of the patient 8 including the input data 102, the output data 104 generated by the computing module 30, and the clinical data 106 obtained from the actual treatment process 120. The physician 8 may then send the profile 100 to the database 26 (step 292). The profile 100 is added to the database 26 and used to generate new characteristics and corresponding weighting coefficients (step 294). Thus, the computing modules 30 may be trained and improved in diagnosing and providing efficient treatments (step 296).

Furthermore, the computing modules 30 are adaptable to new medical discoveries. As other characterizations of medical data become significant, the computing modules 30 need to reflect these new factors. As would be understood by one skilled in the art, the computing modules 30 may be constantly modified to incorporate additional characterizations. These additional characterizations may be extracted from existing profiles 100 stored within the database 26 and used to generate corresponding correlation coefficients and modify the computing modules 30. In this manner, the computing modules 30 may be improved and maintained concurrent to developing discoveries.

Since there are limited combinations of characterizations of medical image information, with each additional profile 100 added to the database 26, the computing modules 30 become more comprehensive and better to recommend potential treatments 112 and probable treatment results 114. The system 1 is capable of integrating a substantial amount of profiles 100 into the database 26 and generating the computing modules 30 which produce results that closely mimic actual individual treatments and treatment results, as opposed to purely extrapolated theoretical output data, which may be less accurate and reliable.

The present invention provides a more personalized system 1 and method 200 for diagnosis and treatment of patients 10. The resulting output data 104 is personalized to the patient's risk factors and health condition. As opposed to the traditional form of diagnosis and treatment using broad generalizations and categories, the system 1 responds to the needs and preferences of each patient 10. Patients 10 are not fitted to a predetermined category. Rather, the diagnosis and treatments conform to the patients 10, providing a more compatible and comfortable means for providing medical care.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention. Those skilled in the art will recognize that the steps described herein may be done in various sequences and the flow sequence described herein is merely by way of example and not limitation. Similarly the data flow and data handling described above may be modified in various ways while still accomplishing the results intended.

What is claimed is:

1. A method, comprising the steps of:
compiling a historical database including a plurality of records, each record including a personal profile and diagnosis data for a person;
deriving a plurality of characterizations and corresponding weighting coefficients based on the records in the historical database;
obtaining pre-diagnostic patient profile data for a selected patient;
generating, with at least one computing module, output data as a function of (i) the pre-diagnostic patient profile data and (ii) the plurality of characterizations and corresponding weighting coefficients, the output data including at least one of a preliminary diagnostic data, a confirmation action plan, a confirmation patient profile data and a therapeutic action plan.

2. The method according to claim 1, further comprising the steps of:
updating the historical database with the pre-diagnostic patient profile data and the output data; and
repeating the deriving step based on the records in the updated historical database to generate the plurality of characterizations and weighting coefficients.

3. The method according to claim 1, wherein the characterizations are include at least one of patient's height, weight, size of a nodule, a location of the nodule, demographics data and physical data.

4. The method according to claim 1, wherein the pre-diagnostic patient profile data includes medical imaging data.

5. The method according to claim 4, wherein the medical imaging data is generated by performing at least one of Computerized Tomography scan, Magnetic Resonance Imaging, Positron Emission Technology, X-Rays, Vascular Interventional and Angiogram/Angiography procedures, ultrasound imaging, radiographs, optical imaging, pathological imaging, molecular imaging and medical genetic imaging.

6. The method according to claim 1, wherein the computing module includes at least one of a programmable data processor, an adaptive processor, an adaptive self-learning error correction system, an automated recognition system and a neural network.

7. The method according to claim 1, wherein the personal profile includes at least one of patient's symptoms, family history, state of health, chronic diseases, allergies, illnesses and lifestyle information correlated to patient's diagnosis data.

8. The method according to claim 7, wherein the diagnosis data includes at least one of a patient diagnose, a suggested diagnosis plan, an actualized diagnostic plan, a treatment plan, an actual treatment plan and information utilized for diagnosis and treatment of the patient.

9. The method according to claim 1, wherein the generating step includes the sub-step of:
(a) generating, using a diagnostic computing module, the preliminary diagnostic data as a function of (i) the pre-diagnostic patient profile data and (ii) the plurality of characterizations and weighting coefficients.

10. The method according to claim 9, wherein generating step further includes the sub-steps of:
(b) providing the pre-diagnostic patient profile data to a physician for adjustment;
(c) obtaining adjusted pre-diagnostic patient profile data from the physician; and
(d) repeating the sub-step (a), to generate further preliminary diagnostic data as a function of (i) the adjusted pre-diagnostic patient profile data and (ii) the plurality of characterizations and weighting coefficients.

11. The method according to claim 1, wherein the generating step further includes the sub-step of:
(a) generating, using a confirmation computing module, the confirmation action plan as a function of (i) the pre-diagnostic patient profile data, (ii) the preliminary diagnostic data and (iii) the plurality of characterizations and weighting coefficients.

12. The method according to claim 11, wherein the generating step further includes the sub-steps of:
(b) providing the pre-diagnostic patient profile data and the preliminary diagnostic data to the physician for adjustment;
(c) obtaining at least one of (i) adjusted pre-diagnostic patient profile data and (ii) adjusted preliminary diagnostic data from the physician; and
(d) repeating the sub-step (a) to generate further confirmation action plan as a function of at least one of (i) the adjusted pre-diagnostic patient profiled data, (ii) the adjusted preliminary diagnostic data and (iii) the plurality of characterizations and weighting coefficients.

13. The method according to claim 1, wherein the generating step further includes the sub-steps of:
(a) obtaining the confirmation patient profile data from the patient based on the confirmation action plan.

14. The method according to claim 13, wherein the generating step further includes the sub-steps of:
(b) providing the confirmation action plan to the physician for adjustment;
(c) obtaining adjusted confirmation action plan from the physician; and
(d) obtaining the confirmation patient profile data from the patient according to the adjusted confirmation action plan.

15. The method according to claim 1, wherein the generating step further includes the sub-step of:
(a) generating, using a treatment computing module, the therapeutic action plan as a function of (i) the pre-diagnostic patient profile data, (ii) the preliminary diagnosis data, (iii) the confirmation patient profile data and (iv) the plurality of characterizations and weighting coefficients.

16. The method according to claim 15, wherein the generating step further includes the sub-steps of:
(b) providing the pre-diagnostic patient profile data, the preliminary diagnostic data, and the confirmation patient profile data to the physician for adjustment;
(c) obtaining at least one of (i) the adjusted pre-diagnostic patient profile data, (ii) the adjusted preliminary diagnostic data and (iii) the adjusted confirmation patient profile data from the physician; and
(d) repeating the sub-step (a) to generate further therapeutic action plan as a function of at least one of (i) the adjusted pre-diagnostic patient profiled data, (ii) the adjusted preliminary diagnostic data, (iii) the adjusted confirmation patient profile data and (iv) the plurality of characterizations and weighting coefficients.

17. The method according to claim 1, wherein the generating step further includes the sub-steps of:
(a) generating, using a diagnostic computing module, the preliminary diagnostic data as a function of (i) the pre-diagnostic patient profile data and (ii) the plurality of characterizations and weighting coefficients;
(b) generating, using a confirmation computing module, the confirmation action plan as a function of (i) the pre-diagnostic patient profile data, (ii) the preliminary diagnostic data and (iii) the plurality of characterizations and weighting coefficients;
(c) obtaining the confirmation patient profile data from the patient based on the confirmation action plan; and
(d) generating, using a treatment computing module, the therapeutic action plan as a function of (i) the pre-diagnostic patient profile data, (ii) the preliminary diagnosis data, (iii) the confirmation patient profile data and (iv) the plurality of characterizations and weighting coefficients.

18. A system, comprising:
a historical database compiling a plurality of records, each record including a personal profile and diagnosis data for a person; and
at least one computing module generating output data for a selected patient as a function of (i) the pre-diagnostic patient profile data and (ii) the plurality of characterizations and corresponding weighting coefficients, the output data including at least one of a preliminary diagnostic data, a confirmation action plan, a confirmation patient profile data and a therapeutic action plan, wherein the plurality of characterizations and corresponding weighting coefficients are derived based on the records in the historical database.

19. The system according to claim 18, wherein the historical database is updated with the pre-diagnostic patent profile data and the output data.

20. The system according to claim 19, wherein the plurality of characterizations and weighting coefficients are derived based on the records in the updated historical database.

21. The system according to claim 18, wherein the characterizations include at least one of the patient's height, weight, size of a nodule, a location of the nodule, demographics data and physical data.

22. The system according to claim 18, wherein the pre-diagnostic patient profile data includes medical imaging data.

23. The system according to claim 22, wherein the medical imaging data is generated by performing at least one of Computerized Tomography scan, Magnetic Resonance Imaging, Positron Emission Technology, X-Rays, Vascular Interventional and Angiogram/Angiography procedures, ultrasound imaging, radiographs, optical imaging, pathological imaging, molecular imaging and medical genetic imaging.

24. The system according to claim 18, wherein the computing module includes at least one of a programmable data processor, an adaptive processor, an adaptive self-learning error correction system, an automated recognition system and a neural network.

25. The system according to claim 18, wherein the personal profile includes at least one of patient's symptoms, family history, state of health, chronic diseases, allergies, illnesses and lifestyle information correlated to patient's diagnosis data.

26. The system according to claim 18, wherein the diagnosis data includes at least one of a patient diagnose, a suggested diagnosis plan, an actualized diagnostic plan, a treatment plan, an actual treatment plan and information utilized for diagnosis and treatment of the patient.

27. The system according to claim 18, wherein the preliminary diagnostic data of the output data is generated using a diagnostic computing module of the at least one computing module as a function of (i) the pre-diagnostic patient profile data and (ii) the plurality of characterizations and corresponding weighting coefficients.

28. The system according to claim 27, wherein the pre-diagnostic patient profile data is adjusted by a physician; and wherein the preliminary diagnostic data is further generated as a function of (i) the adjusted pre-diagnostic patient profile data and (ii) the plurality of characterizations and weighting coefficients.

29. The system according to claim 18, wherein the confirmation action plan of the output data is generated using a confirmation computing module of the at least one computing module as a function of at least one of (i) the pre-diagnostic patient profile data, (ii) the preliminary diagnostic data and (iii) the plurality of characterizations and corresponding weighting coefficients.

30. The system according to claim 29, wherein at least one of (i) the pre-diagnostic patient profile data and (ii) the preliminary diagnostic data is adjusted by a physician; and wherein the confirmation action plan is further generated as a function of at least one of (i) the adjusted pre-diagnostic patient profiled data, (ii) the adjusted preliminary diagnostic data and (iii) the plurality of characterizations and weighting coefficients.

31. The system according to claim 18, wherein the confirmation patient profile data is collected from the patient based on the confirmation action plan.

32. The system according to claim 31, wherein the confirmation action plan is adjusted by a physician; and wherein the confirmation patient profile is further collected from the patient according to the adjusted confirmation action plan.

33. The system according to claim 18, wherein the therapeutic action plan of the output data is generated using a treatment computing module of the at least one computing module as a function of (i) the pre-diagnostic patient profile data, (ii) the preliminary diagnosis data, (iii) the confirmation patient profile data and (iv) the plurality of characterizations and corresponding weighting coefficients.

34. The system according to claim 33, wherein at least one of (i) the pre-diagnostic patient profile data, (ii) the preliminary diagnostic data and (iii) the confirmation patient profile data is adjusted by a physician; and wherein the therapeutic action plan is further generated as a function of at least one of (i) the adjusted pre-diagnostic patient profiled data, (ii) the adjusted preliminary diagnostic data, (iii) the adjusted confirmation patient profile data and (iv) the plurality of characterizations and weighting coefficients.

35. The system according to claim 18, wherein the preliminary diagnostic data of the output data is generated using a diagnostic computing module of the at least one computing module as a function of (i) the pre-diagnostic patient profile data and (ii) the plurality of characterizations and corresponding weighting coefficients; wherein the confirmation action plan of the output data is generated using a confirmation computing module of the at least one computing module as a function of (i) the pre-diagnostic patient profile data, (ii) the preliminary diagnostic data and (iii) the plurality of characterizations and weighting coefficients; wherein the confirmation patient profile data is collected from the patient based on the confirmation action plan; and wherein the therapeutic action plan of the output data is generated using a treatment computing module of the at least one computing module as a function of (i) the pre-diagnostic patient profile data, (ii) the preliminary diagnosis data, (iii) the confirmation patient profile data and (iv) the plurality of characterizations and weighting coefficients.

36. The system according to claim 35, wherein the pre-diagnostic patient profile is adjusted by a physician; wherein the preliminary diagnostic data of the output data is further generated using a diagnostic computing module as a function of at least one of (i) the adjusted pre-diagnostic patient profile data and (ii) the plurality of characterizations and weighting coefficients; wherein the preliminary diagnostic data is adjusted by the physician; wherein the confirmation action plan of the output data is further generated using the confirmation action plan as a function of at least one of (i) the adjusted pre-diagnostic patient profile data, (ii) the adjusted preliminary diagnostic data and (iii) the plurality of characterizations and weighting coefficients; wherein the confirmation action plan is adjusted by the physician; wherein the confirmation patient profile data is further collected from the patient based on the adjusted confirmation action plan; and wherein the confirmation patient profile data is adjusted by the physician; wherein the therapeutic action plan of the output data is further generated using a treatment computing module as a function of at least one of (i) the adjusted pre-diagnostic patient profile data, (ii) the adjusted preliminary diagnosis data, (iii) the adjusted confirmation patient profile data and (iv) the plurality of characterizations and weighting coefficients.
